(19) United States
(12) Patent Application Publication
(10) Pub. No.: US 2024/0194033 A1
(43) Pub. Date: Jun. 13, 2024

(54) System and methods for event outcome selection

(71) Applicants: Jeremy Earl Tucker, New York, NY (US); Anthony Sawyer, Jr., Denver, CO (US)

(72) Inventors: Jeremy Earl Tucker, New York, NY (US); Anthony Sawyer, Jr., Denver, CO (US)

(21) Appl. No.: 18/554,646

(22) PCT Filed: Apr. 8, 2022
(86) PCT No.: PCT/US22/24090

§ 371 Date: Oct. 10, 2023

Related U.S. Application Data
(60) Provisional application No. 63/173,384, filed on Apr. 10, 2021.

(51) Int. Cl. G07F 17/32; G06Q 50/34

(52) U.S. Cl. CPC G07F 17/3288; G06Q 50/34; G07F 17/323

(57) ABSTRACT

Systems and methods for event outcome selection that permit the loading of user profiles from other systems into an event outcome selection server. The event outcome selection server also receives events, each event having a plurality of outcomes, each outcome being associated with a payout associated with an implied probability of the occurrence of the outcome. The implied probabilities are converted and normalized before presentation to users via an interface that permits the user to select an outcome via a swiping gesture. An administrative interface permits privileged users to change outcome selections made by other users.

### CROSS-REFERENCE TO RELATED APPLICATIONS

This application claims the benefit of and priority to U.S. Provisional Patent Application No. 63/173,384, filed Apr. 10, 2021, the entire disclosure of which is hereby incorporated by reference as if set forth in its entirety herein.

### TECHNICAL FIELD

The invention relates generally to event outcome selection systems, and more particularly, to a competitive event outcome selection system with simplified choices.

### BACKGROUND

Networking architectures have grown increasingly complex in communications environments. In recent years, a series of protocols and configurations have been developed in order to accommodate a diverse group of end-users having various communication needs. Many of these architectures have gained significant notoriety because they can offer the benefits of automation, convenience, management and enhanced consumer selections.

Certain protocols may be used in order to allow an end-user to make a selection on event outcomes. These protocols may relate to free-to-play games and betting in politics, securities or entertainment (e.g., music, sports, movies, television, gaming, etc.). Certain subgenres of entertainment like basketball or reality TV, also known as entertainment offerings, have event offerings-events promoted by an event offeror—that attract active or passive participation by end-users. For example, an NBA (the event offeror) regular-season game between the Utah Jazz and Boston Celtics would qualify as an event offering.

Many of these event offerings allow end-users the ability to predict event outcomes. Participants typically base their selections on randomness, favoritism, popular or expert opinion, self-directed research or published bookmaker odds. While some believe that bookmaker odds are simple to understand in discerning the likelihood of an event outcome, many have issues with comprehending and deciphering these probabilities.

For example, a participant looking to make a prediction on an event should have an idea of who the favorite is, and if they don't, they should be able to determine it based on the odds associated with the various options. However, there are several obstacles and barriers that must be overcome by participants, especially those without knowledge of said event and the various representations of bookmaker odds.

One problem is the same event can have multiple labeled types, where a labeled type is a grouping of an implicit question and odds associated with a unique event outcome. Thus, an individual is required to understand an implicit question derived from idiomatic terms within the betting space that describe various betting types, e.g., fixed-odds (or moneyline), point spread (or spreads), over-under (or O/U), parimutuel (or mutual betting or tote), etc.

Without prior knowledge or experience, users must conduct research and perform calculations to comprehend the labeled types. This effort may cause participants to refrain from free-to-play games or betting around an event offering.

Another problem is that there are a variety of odds notations which are distinctively different. Odds notations are a unique representational system of quoting odds; many times they vary from region to region. For example, there are decimal (i.e., European), fractional, money line (i.e., American) odds and many other notations used to display the likelihoods of an event outcome. Identifying, comprehending and converting these various odds notations to meaningful representations can be trying for a user attempting to make, e.g., an in-game prediction.

Another problem is that event data is not isolated or present in a centralized platform to display to the user once a selection has been made. Having to track and review isolated data across different mediums during and after events are complete can be a time-consuming task for a user. This inefficiency may deter users from participating overall due to the required effort needed once an outcome selection is made around a free-to-play game or betting event offering.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

The present disclosure is related to systems and methods enabling outcome selection by users, with the selection process involving a simplified user interface that permits users to select among various event outcomes by swiping, with the user interface presenting simplified, normalized probability information for each outcome. A single server may import user profiles and event outcome selection histories from other servers. Additional user interfaces permit administrators to change event outcome selections made by users.

In one aspect, embodiments of the present invention relate to a computer-implemented method of event outcome selection including electronically receiving, by a first computer system, at least one user profile via an interface configured to communicate with at least one other computer system, the user profile including at least one event outcome selection made by a user associated with the user profile; electronically receiving, by the first computer system, at least one event having a plurality of outcomes, each outcome associated with a payout associated with an implied probability of occurrence of the outcome; converting, by the first computer system, each implied probability of occurrence to a normalized value; and communicating, by the first computer system via the interface, a first graphical user interface for display to the user associated with the user profile, the first graphical user interface allowing the user to choose among a plurality of outcomes using a swiping gesture, each of the plurality of outcomes being associated with a converted normalized value.

In some embodiments the method further includes communicating, by the first computer system via the interface, a second graphical user interface for display to an administrative user, the second graphical user interface enabling the administrative user to alter at least one event outcome selection associated with a user profile.

In some embodiments the method further includes communicating, by the first computer system via the interface, a second graphical user interface for display to an administrative user, the second graphical user interface enabling the administrative user to create a user pool based on a seed user.

In some embodiments the method further includes communicating, by the first computer system via the interface, a second graphical user interface for display to an administrative user, the second graphical user interface enabling the administrative user to seamlessly interact with a user profile originated at the first computer system and at least one user profile received from at least one other computer system.

In some embodiments the method further includes filtering, by the first computer system, at least one received event using at least one of user signals, user characteristics, event offering participation, and event outcome selections associated with the user profile; and presenting, using the first graphical user interface, the list of filtered events to the user and receiving user choices for each of the filtered events. In some embodiments the presented list of filtered events is ordered according to user preferences.

In some embodiments the method further includes communicating, by the first computer system via the first graphical user interface, additional outcomes based on the outcomes chosen by the user using the first graphical user interface.

In another aspect, embodiments of the present invention relate to a non-transitory computer-readable medium including instructions for event outcome selection that, when executed by a processor, are configured to electronically receive, by a first computer system, at least one user profile via an interface configured to communicate with at least one other computer system, the user profile including at least one event outcome selection made by a user associated with the user profile; electronically receive, by the first computer system, at least one event having a plurality of outcomes, each outcome associated with a payout associated with an implied probability of occurrence of the outcome; convert, by the first computer system, each implied probability of occurrence to a normalized value; and communicate, by the first computer system via the interface, a first graphical user interface for display to the user associated with the user profile, the first graphical user interface allowing the user to choose among a plurality of outcomes using a swiping gesture, each of the plurality of outcomes being associated with a converted normalized value.

In some embodiments the medium further includes instructions for communicating, by the first computer system via the interface, a second graphical user interface for display to an administrative user, the second graphical user interface enabling the administrative user to alter at least one event outcome selection associated with a user profile.

In some embodiments the medium further includes instructions for communicating, by the first computer system via the interface, a second graphical user interface for display to an administrative user, the second graphical user interface enabling the administrative user to create a user pool based on a seed user.

In some embodiments the medium further includes instructions for communicating, by the first computer system via the interface, a second graphical user interface for display to an administrative user, the second graphical user interface enabling the administrative user to seamlessly interact with a user profile originated at the first computer system and at least one user profile received from at least one other computer system.

In some embodiments the medium further includes instructions for filtering, by the first computer system, at least one received event using at least one of user characteristics, user signals, event offering participation, and event outcome selections associated with the user profile; and presenting, using the first graphical user interface, the list of filtered events to the user and receiving user choices for each of the filtered events. In some embodiments the instructions for presenting the list of filtered events to the user include instructions for presenting the list of filtered events ordered according to user preferences.

In some embodiments the medium further includes instructions for communicating, by the first computer system via the first graphical user interface, additional outcomes based on the outcomes chosen by the user using the first graphical user interface.

In still another aspect, embodiments of the present invention relate to a computer system for event outcome selection including a processor configured to receive at least one event having a plurality of outcomes each outcome associated with a payout associated with an implied probability of occurrence of the outcome and convert each implied probability of occurrence to a normalized value; and an interface coupled to the processor and operable to electronically receive at least one user profile from at least one other computer system, the user profile including at least one event outcome selection made by a user associated with the user profile and communicate a first graphical interface for display to the user associated with the user profile, the first graphical user interface allowing the user to choose among a plurality of outcomes using a swiping gesture, each of the plurality of outcomes being associated with a converted normalized value.

In some embodiments the interface is further operative to communicate a second graphical user interface for display to an administrative user, the second graphical user interface enabling the administrative user to alter at least one event outcome selection associated with a user profile.

In some embodiments the interface is further operative to communicate a second graphical user interface for display to an administrative user, the second graphical user interface enabling the administrative user to create a user pool based on a seed user.

In some embodiments the interface is further operative to communicate a second graphical user interface for display to an administrative user, the second graphical user interface enabling the administrative user to seamlessly interact with a user profile originated at the first computer system and at least one user profile received from at least one other computer system.

In some embodiments the processor is further configured to filter at least one received event using at least one of user characteristics, user signals, event offering participation, and event outcome selections associated with the user profile; and the first graphical user interface is further configured to present the list of filtered events to the user and receive choices from the user for each of the filtered events.

In some embodiments the first graphical user interface is further configured to present the list of filtered events ordered according to user preferences.

Depending on the specific features implemented, particular embodiments may exhibit some, none or all of the following technical advantages. Various embodiments may be capable of dynamically updating based on event offerings and user activity. In addition, some embodiments may provide the ability to evaluate the engagement and skill level of users. Some embodiments may be capable of importing user profiles from other free-to-play, betting and social-networking systems. Other technical advantages will be readily apparent to one skilled in the art from the following figures, descriptions and claims.

### BRIEF DESCRIPTION OF DRAWINGS

Non-limiting and non-exhaustive embodiments of the invention are described with reference to the following figures, wherein like reference numerals refer to like parts throughout the various views unless otherwise specified:

FIG. 1A is an overview of one embodiment of the event outcome selection system;

FIG. 1B shows the terminal 12 from FIG. 1A in more detail;

FIG. 1C shows the event outcome selection server 14 from FIG. 1A in more detail;

FIG. 1D is a diagram of the database 22a from FIG. 1C showing one embodiment of how an event outcome selection server stores a pool;

FIG. 1E is a diagram of the display 16 from FIG. 1B showing one embodiment of the presentation of search results to a user;

FIG. 1F is a diagram of the display 16 from FIG. 1B showing one embodiment of the presentation of details of a user profile result entity to a user;

FIG. 1G is a diagram of the display 16 from FIG. 1B showing one embodiment of the presentation of details of an event to a user;

FIG. 1H is a diagram of the display 16 from FIG. 1B showing one embodiment of the presentation of details of event outcome selections to a user;

FIG. 2 is a diagram depicting how two platforms may be searched for a user profile, in accordance with a particular embodiment;

FIG. 3 is a flowchart indicating how a result list may be generated, in accordance with a particular embodiment;

FIG. 4 shows one embodiment of the event outcome selection system displaying to a user the event details and normalized labeled type (derived explicit questions and numerical scale representations) of an event;

FIG. 5 shows one embodiment of the event outcome selection system displaying to a user the normalized labeled type (derived explicit questions and numerical scale representations) of an event;

FIG. 6 shows one embodiment of the event outcome selection system displaying to a user the event details and normalized labeled type (derived explicit questions and numerical scale representations) of an event;

FIG. 7 shows one embodiment of the event outcome selection system displaying to a user the normalized labeled type (derived explicit questions and numerical scale representations) of an event;

FIG. 8 is a diagram of the display from FIG. 6 showing the effect of a swipe left gesture;

FIG. 9 is a diagram of the display from FIG. 6 showing the effect of a swipe right gesture;

FIG. 10 is a diagram of the display from FIG. 6 showing the effect of a swipe up gesture;

FIG. 11 is a diagram of the display from FIG. 6 showing the effect of a swipe down gesture;

FIG. 12 is a flowchart indicating how an event offering result list may be generated, in accordance with a particular embodiment; and

FIG. 13 shows one embodiment of the event outcome selection system displaying event results to a user.

Further, persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having the benefit of the description herein.

### DETAILED DESCRIPTION

For the purpose of promoting an understanding of the principles of the disclosure, reference will now be made to the embodiment(s) illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will also be understood by those skilled in the art that the foregoing general description and the following detailed description are exemplary and explanatory of the disclosure and are not intended to be restrictive thereof.

The terms “comprises,” “comprising,” or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment,” “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

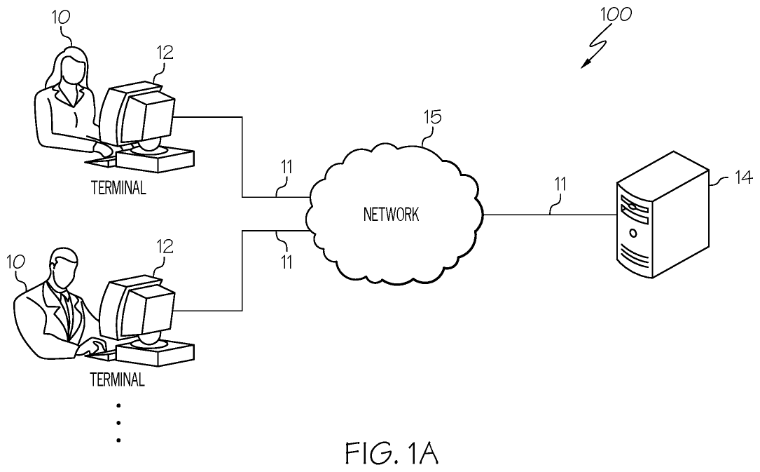

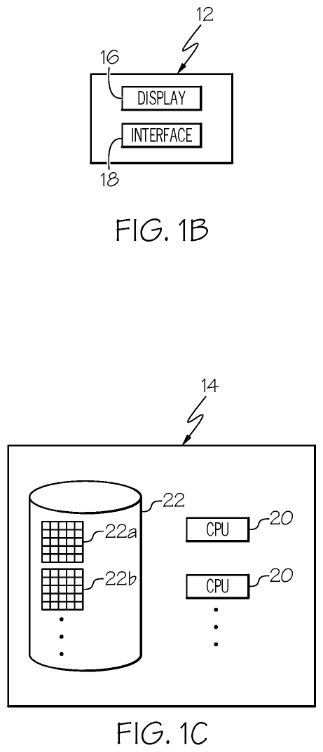

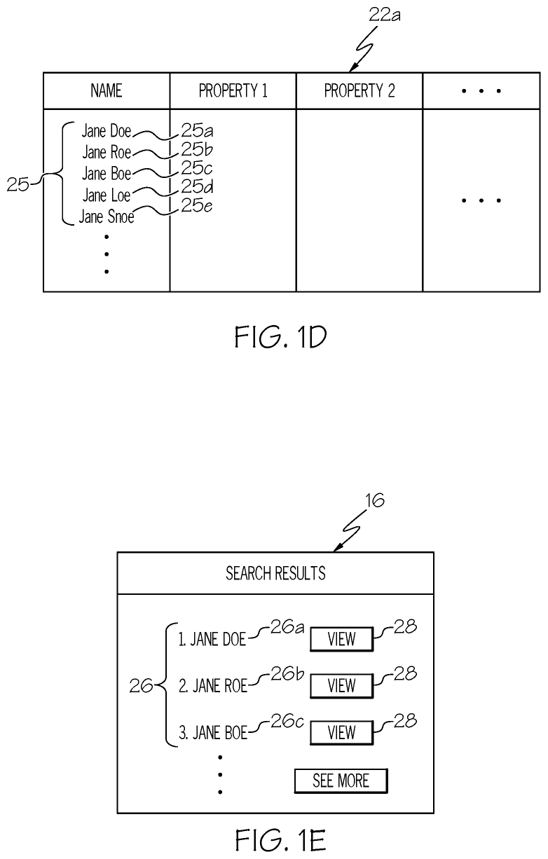

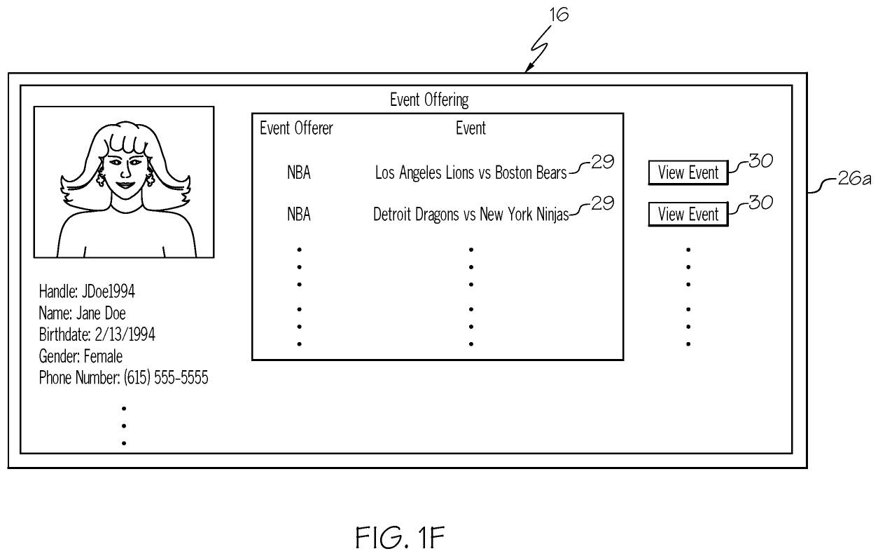

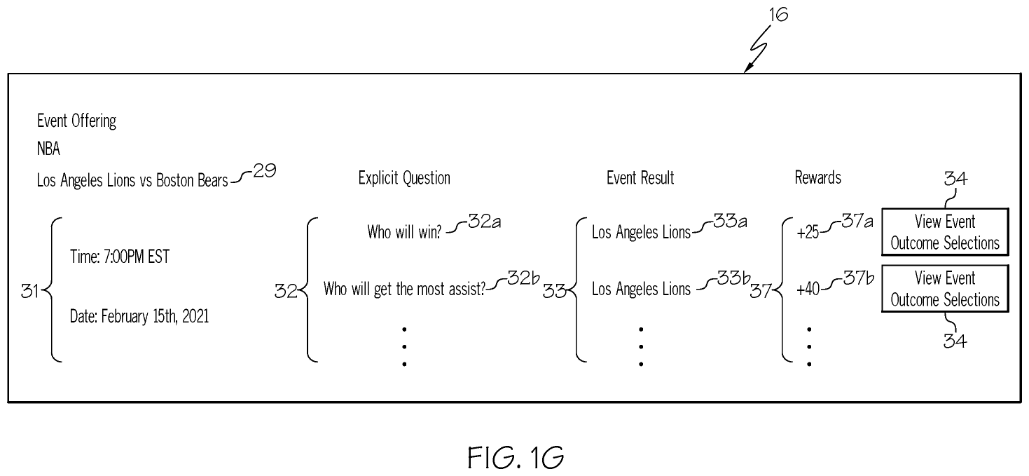

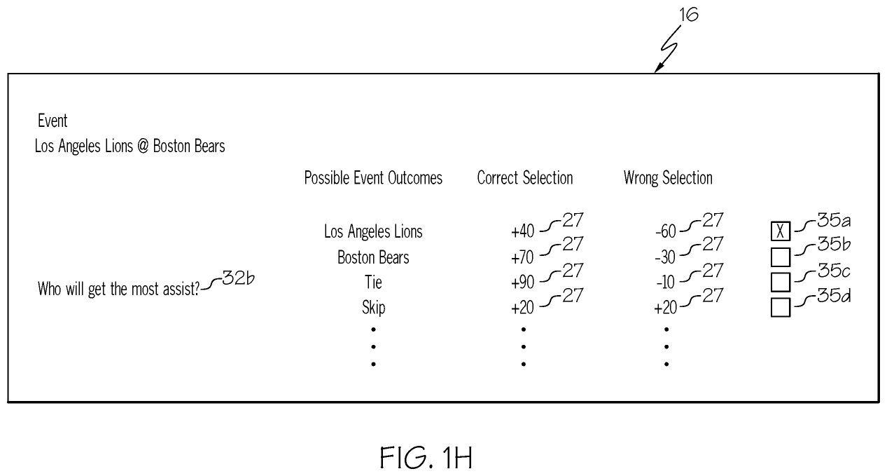

Referring to FIG. 1A, one embodiment of an event outcome selection system is shown. FIG. 1A is a simplified block diagram of a system 100 for facilitating a free-to-play or betting platform in a network environment. In other embodiments, system 100 can be used to enable user selections of possible event outcomes related to entertainment, politics or securities. Users 10 interact with an event outcome selection server 14 through terminals 12. Terminal 12 and event outcome selection server 14 are communicatively coupled via network connections 11 and network 15.

Users 10 are clients, customers, prospective customers, or entities wishing to participate in a free-to-play or betting scenario. Users 10 may also be analysts, operation associates, managers or entities managing and viewing information associated with users and event offerings in the system. Users 10 may also seek to access or initiate communications with other users that may be delivered via network 15.

Users 10 with administrative privileges (i.e., “administrators”) may review data (such as event offerings, for example) associated with other users in order to make or later event outcome selections. Data, as used herein, refers to any type of numeric, voice, video, text, script data or any other suitable information in any appropriate format that may be communicated from one point to another.

Network 15 is a communicative platform operable to exchange data or information emanating from user 10. Network 15 could be a plain old telephone system (POTS). Transmission of information emanating from the user may be assisted by event outcome selection server 14 or manually keyed into a telephone or other suitable electronic equipment. In other embodiments, network 15 could be any packet data network offering a communications interface or exchange between any two nodes in system 100. Network 15 may alternatively be any local area network (LAN), metropolitan area network (MAN), wide area net-work (WAN), wireless local area network (WLAN), virtual private network (VPN), intranet, or any other appropriate architecture or system that facilitates communications in a network or telephonic environment, including a combination of any networks or systems described above. In various embodiments, network connections 11 may include, but are not limited to, wired and/or wireless mediums which may be provisioned with routers and firewalls.

Event outcome selection server 14 is operable to receive and to communicate information to terminal 12. In some embodiments, event outcome selection server 14 may comprise a plurality of servers or other equipment, each performing different or the same functions in order to receive and communicate information to terminal 12 via a network interface. Event outcome selection server 14 may include software and/or algorithms to achieve the operations for processing, communicating, delivering, gathering, uploading, maintaining, and/or generally managing data, as described herein. Alternatively, such operations and techniques may be achieved by any suitable hardware, component, device, application-specific integrated circuit (ASIC), additional software, field-programmable gate array (FPGA), server, processor, algorithm, erasable programmable ROM (EPROM), electrically erasable programmable ROM (EE-PROM), or any other suitable object that is operable to facilitate such operations.

In some embodiments, user 10, using terminal 12, submits information to event outcome selection server 14 about user 10, perhaps when creating a user profile, and the user's preferred event offerings. Such information may include a user handle, which may be a combination of characters that uniquely identifies user 10 to event outcome selection server 14. In various embodiments, event outcome selection server 14 may be configured to collect this information; for example, event outcome selection server 14 may be configured to ask user 10 to respond to a series of questions. Event outcome selection server 14 may be configured to receive the information submitted by user 10 and create a profile for user 10 based on that information, storing the profile in memory 22.

As an example only, consider a case where user 10 is interested in participating in a free-to-play or betting platform. User 10 can access the Internet via terminal 12, travel to a website managed by event outcome selection server 14, and begin the registration process. As part of the registration process, event outcome selection server 14 may ask user 10 a series of questions which identifies characteristics about user 10. Thus, event outcome selection server 14 may ask about the age, location and preferred event offerings of user 10. After concluding the registration process, event outcome selection server 14 may store the responses of user 10 as a profile. This same process may be repeated by several different users 10, causing event outcome selection server 14 to contain a plurality of user profiles each containing traits and a plurality of event offerings.

FIG. 1B is a diagram showing, in more detail, the elements of terminal 12. Terminal 12 includes interface 18 (so that user 10 may be able to interact with terminal 12) and display 16. Interface 18 may further comprise any suitable interface for a user such as a video camera, a microphone, a keyboard, a mouse, or any other appropriate equipment according to particular configurations and arrangements. In addition, interface 18 may be a unique element designed specifically for communications involving system 100. Such an element may be fabricated or produced specifically for translating, converting and normalizing data of event probabilities involving an event offering.

Display 16, in one embodiment, is a computer monitor. Alternatively, display 16 may be a projector, speaker, or other device that allows user 10 to appreciate information that system 100 transmits.

In one embodiment, terminal 12 represents (and is inclusive of) a personal computer that may be used to access server 14. Alternatively, terminal 12 may be representative of a cellular telephone, an electronic notebook, a laptop, a personal digital assistant (PDA), or any other suitable device (wireless or otherwise, some of which can perform web browsing) capable of accessing one or more elements within system 100.

In some embodiments, terminal 12 is operable to determine its own geographic location by a global positioning satellite navigational system. Terminal 12 may also determine its own geographic location using cellphone-based triangulation techniques: Wi-Fi-based positioning system, Global Positioning Satellite (GPS) system, or network addresses assigned by a service provider.

FIG. 1C is a diagram showing, in more detail, the event outcome selection server 14. Event outcome selection server 14 includes at least one CPU 20 and memory 22. Memory 22 may store multiple databases, such as databases 22a and 22b. The server 14 will also include at least one network interface (not shown) for communicating data, such as graphical user interfaces, to other computers, such as a terminal 12.

FIG. 1D depicts an embodiment in which event outcome selection server 14 has a database 22a which contains a pool 25. In one embodiment, each pool entity 25a-e represents a user and their profile. In some embodiments, not all registered users are in pool 25. As discussed further below, event outcome selection server 14 may use a selection process for including stored profiles in pool 25. As depicted in FIG. 1D, in this embodiment, the collection of users and profiles forms pool 25 through which event outcome selection server 14 may perform various functions such as searches for event outcome selections on various event offerings.

For example, an administrator may use event outcome selection server 14 to search through pool 25 and present event outcome selections of event offerings to the administrator. In FIG. 1E, one embodiment of this presentation is depicted as occurring through display 16. In various embodiments, event outcome selections of event offerings may be presented to administrators utilizing other communication schemes, such as electronic messages (i.e., e-mail) or text messages (i.e., utilizing SMS). In the depicted embodiment, a result list 26 is presented to the administrator. A user entity 26a in a result list 26 may be associated with a view button 28. Using interface 18, administrator may request that event outcome selection server 14 provide more information about an entity in result list 26 by pressing the associated view button 28. Event outcome selection server 14 may then communicate to the administrator more information about that entity by retrieving the information from memory 22.

In FIG. 1F, one embodiment of information that event outcome selection server 14 provides for the administrator regarding entity 26a is shown. Using display 16, an administrator views an entity and its event offerings participated in from result list 26. In one embodiment, event outcome selection server 14 may provide the administrator with contact information of the entity 26a such as a telephone number and/or an e-mail address; in another embodiment, event outcome selection server 14 may provide the administrator with a way to directly contact the entity 26a, such as sending a message or providing voice or video communication between the administrator and the entity 26a. Event outcome selection server 14 may be further configured to allow the administrator to view events to express a change in an event outcome selection made by entity 26a or another user 10. Using interface 18, the administrator may request that event outcome selection server 14 provide more information on an event 29 in displayed entity's profile by pressing the associated view event button 30. Event outcome selection server 14 may then communicate to the administrator more information about that event 29 by retrieving the information from memory 22.

In FIG. 1G, one embodiment of information that event outcome selection server 14 provides for event 29 is shown. Using display 16, the administrator views an event 29. In this embodiment, event outcome selection server 14 may provide the administrator with event details 31, explicit questions 32, event results 33 and rewards 37. Furthermore, event outcome selection server 14 may be configured to allow the administrator to view event outcome selections to express a change in event outcome selection preference for the user entity 26. Using interface 18, the administrator may request that event outcome selection server 14 provide more information on event outcome selections in the user entity profile by pressing the associated view event outcome selections button 34. Event outcome selection server 14 may then communicate to the administrator more information about that event by retrieving the information from memory 22.

In FIG. 1H, one embodiment of information that event outcome selection server 14 provides for event outcome selections is displayed. Using display 16, the administrator views possible event outcomes and their respective reward breakdowns 27 for correct and wrong event outcome selections. In various embodiments, the administrator may communicate to the event outcome selection server 14 with an event outcome selection preference 35 of an explicit question 32b. The event outcome selection server does not have to accept a request from the administrator given certain event details.

As an example only, consider that the administrator has submitted a search request to event outcome selection server 14. Event outcome selection server 14 may search through pool 25, identify results and communicate the result list 26 to the administrator which could contain other user entities for whom event outcome selection server 14 had created a profile and who were identified through a search and selection process. Next, the administrator may be interested in learning more about Jane Doe, user profile result entity 26a; thus, the administrator would click view event button 30 associated with Jane Doe. Event outcome selection server 14 would receive this request and respond by displaying Jane Doe's profile (stored in memory 22), as depicted in FIG. 1F. Next, after reading the profile, the administrator may be interested in contacting Jane Doe. Therefore, the administrator would use the contact information in the profile and/or event outcome selection server 14 would respond by allowing the administrator to enter a message that event outcome selection server would then communicate to Jane Doe.

After communicating with Jane Doe, Jane Doe may request the administrator to change Jane Doe's event outcome selection 35a associated with the NBA event Los Angeles Lions v. Boston Bears. Hence, the administrator would click the view event button 30. Event outcome selection server 14 may search through event 29 identifying event details 31, explicit questions 32 and view event outcome selection button 34. The administrator would click view event outcome selections button 34 associated with the specific event 29 and explicit question 32 that Jane Doe requested to alter. Event outcome selection server 14 would receive this request and respond by displaying possible event outcomes, rewards breakdown of correct and wrong selections 27, Jane Doe's selected event outcome 35a and unselected event outcomes 35b-35d. Lastly, the administrator would submit to the event outcome selection server 14 an event selection outcome between 35b-35d to fulfill Jane Doe's request, and event outcome selection server 14 may not affirm the request change if the request submitted was after the event start time.

In one embodiment, event outcome selection server 14 may remove user profiles and event offerings from user profiles. As an example, the entity 25a may be removed from pool 25 of users; in another embodiment, event outcome selection server 14 may remove event 29 from event offerings of entity 25a.

In another embodiment, event outcome selection server 14 may add profiles and event offerings to profiles. As an example, previously removed entity 25a may be added back to pool 25 of users; in another embodiment, event outcome selection server 14 may add event 29 to event offerings of entity 25a.

In some embodiments, event outcome selection server 14 may be configured to generate pool 25 by default according to various characteristics, event offerings and event outcome selections of user 10 and other users of the system. Event outcome selection server 14 may also restrict entities from being included in pool 25 based on the status of the profile, or if user 10 has rejected or blocked an entity. For example, event outcome selection server 14 may not allow profiles that are not in good standing to be included in pool 25. Any suitable method can be used to determine which entities are included in pool 25. For example, any characteristics, event offerings, events or algorithms described herein may form the basis of such a determination.

Event outcome selection server 14 may further be configured to update pool 25. In some embodiments, event outcome selection server 14 may do so by creating new seed entities based on activity by user 10, such as indicating a preference for a particular event offering.

As an example only, consider the case in which the administrator has requested a search and received from event outcome selection server 14 results list 26 as shown in FIG. 1E. Then, the administrator decides to submit Jane Doe as a seed to event outcome selection server 14. Event outcome selection server 14 will designate Jane Doe's profile as a seed then compare Jane Doe's profile to other profiles stored in memory 22 in order to identify other users who may be similar to Jane Doe which will be displayed to the administrator.

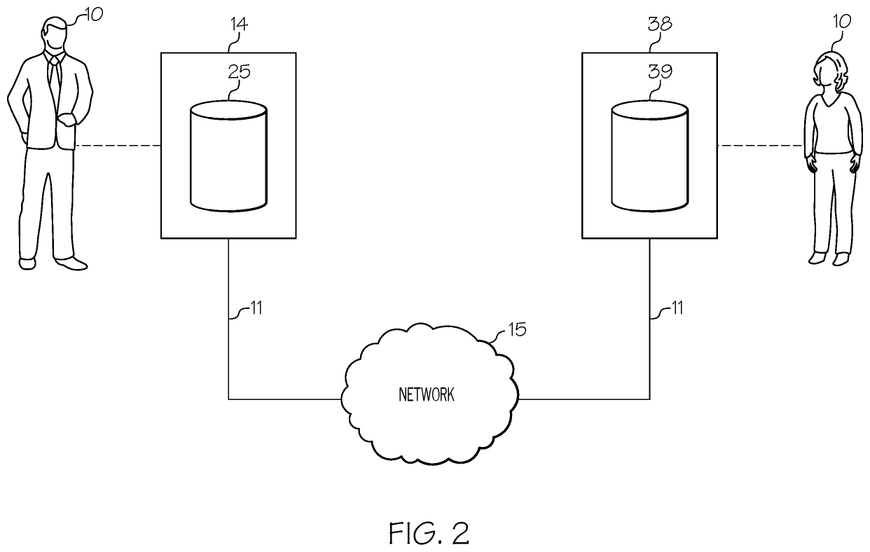

In FIG. 2, one embodiment is disclosed wherein event outcome selection server 14, with pool 25, may be configured to interact with another platform, such as free-to-play, betting and social networking platforms 38, containing a set 39 of users. Users 10 are communicatively coupled to event outcome selection server 14 and free-to-play, betting and social networking platforms 38. Event outcome selection server 14 may further be configured to provide users of free-to-play, betting and social networking platforms 38 a service by which they may search for users within set 39 or within pool 25 using the algorithms and processing of event outcome selection server 14. Event outcome selection server 14 may even further be configured to allow users of event outcome selection server 14 to search through pool 25 and set 39. Event outcome selection server 14 may be configured to parse the profiles of the entities in set 39, collecting data and applying algorithms.

In another embodiment, event outcome selection server 14 may be configured to allow users of free-to-play, betting and social networking platforms to interact with event outcome selection server 14 using free-to-play, betting and social networking platforms 38. This level of integration provides the advantage of users not having to learn and sign up for a different platform.

Free-to-play, betting and social networking platforms 38, in one embodiment, may be a service that stores profiles of set of users 39. This service may be further configured to provide access to the stored profiles. In one embodiment, free-to-play, betting and social networking platforms 38 may also allow other services to interact with set of users 39 of free-to-play, betting and social networking platforms 38 through free-to-play, betting and social networking platforms 38.

In one embodiment, event outcome selection server 14 may be configured to collect requests from users of free-to-play, betting and social networking platforms 38 and perform a search through pool 25 and set 39. Event outcome selection server 14 may further be configured to present the results of this search from within free-to-play, betting and social networking platforms 38. Event outcome selection server 14 may further be configured to present entities in the search result from pool 25 as if they were entities of set 39; in one embodiment, event outcome selection server 14 may be configured to generate profiles of entities from pool 25 into set 39. Thus, users of free-to-play, betting and social networking platforms 38 may view all of the entities in the search result, regardless of their source (either from pool 25 or set 39), within the environment of free-to-play, betting and social networking platforms 38.

As an example only, consider two users: Billy, for whom event outcome selection server 14 has created a profile, and Molly, who has a profile stored in free-to-play, betting and social networking platforms 38. From within free-to-play, betting and social networking platforms 38, event outcome selection server 14 presents to Molly the ability to perform a search that Molly uses. The results of this search are presented to Molly within free-to-play, betting and social networking platforms 38. In this example, Billy's profile is displayed to Molly as a search result along with other entities from set 39 though Billy's profile was from pool 25. In this example, event outcome selection server 14 uses the algorithms discussed herein and searches through the profiles stored in pool 25 and set 39. In order to display Billy's profile to Molly, event outcome selection server 14 creates a profile in set 39 using the data stored in Billy's profile in pool 25. Molly is then able to interact with this newly created profile from within free-to-play, betting and social networking platforms 38 in the same manner as she is other entities in set 39.

In another embodiment, event outcome selection server 14 may be configured to allow its users to interact with free-to-play, betting and social networking platforms 38 through event outcome selection server 14. In one embodiment, event outcome selection server 14 supplements pool 25 with set 39. In yet another embodiment, entities from set 39 appear as entities of pool 25 to the user in their list of search results. In one embodiment, event outcome selection server 14 may be configured to generate profiles within pool 25 from entities of set 39; the system may be configured to do so through capabilities provided by free-to-play, betting and social networking platforms 38, such as an application programming interface.

In some embodiments, event outcome selection server 14 may import profiles from other social networking systems. This level of integration provides the advantage of users only having to update their profile information in one place. For example, when user 10 updates his profile within free-to-play, betting and social networking platform 38, event outcome selection server 14 is also able to access the updated profile information.

In some embodiments, event outcome selection server 14 may further be configured, as part of the user registration process, to link to a user's existing profile within free-to-play, betting and social networking platforms 38. Event outcome selection server 14 may be configured to parse the profiles of the users in set 39, e.g., collecting data and applying algorithms. For example, event outcome selection server 14 may use explicit signals from free-to-play, betting and social networking platforms 38, such as common friends, common interests, common network, location, gender, age or event offering preferences to evaluate event outcome selections within events of event offerings of user 10. Event outcome selection server 14 may also use implicit signals for such as whom a user 10 expresses a preference of certain event offerings or outcome selections occurring within various events of event offerings. Implicit signals may also include facial recognition algorithms to detect ethnicity, hair color, eye color, etc., of profiles that user 10 has expressed interest in. Additional implicit signals may also include image recognition algorithms to detect logos, symbols, signs, icons, etc., of profiles that user 10 has expressed interest in.

In particular embodiments, event outcome selection server 14 may have user 10 link their user profiles to an existing profile within free-to-play, betting and social networking platforms 38. Event outcome selection server 14 may be configured to generate and add profiles to user profile pool 25 from user set 39; the system may be configured to do so through capabilities provided by free-to-play, betting and social networking platforms 38, such as an application programming interface. One advantage of linking is that event outcome selection server 14 can use the authentication features provided by free-to-play, betting and social networking platforms 38. For example, creating a user profile on event outcome selection server 14 containing false information becomes harder when the information must come from another verifiable and peer monitored source such as free-to-play, betting and social networking platforms 38.

As an example only, consider two users: Billy, whose profile is stored in event outcome selection server 14, and Molly, whose profile is stored in free-to-play, betting and social networking platforms 38. Billy submits a search request to event outcome selection server 14. Event outcome selection server 14 may return result list 26 to Billy, which, in this example, contains an entity representing Molly's profile. Event outcome selection server 14 may accomplish this by creating profiles in pool 25 that correspond to the profiles found in set 39.

Once these profiles have been imported into pool 25, event outcome selection server 14 may then search through pool 25. While doing so, event outcome selection server 14 applies the algorithms discussed herein. Thus, in this example, event outcome selection server 14 has been configured to both search and apply algorithms to entities in pool 25 and set 39. Further, in one example, Billy is not able to distinguish that Molly's profile was originally stored in free-to-play, betting and social networking platforms 38. Rather, event outcome selection server 14 presents Molly's profile in the same manner as other profiles stored in pool 25. Thus, in this example, Billy may use view button 28, view event 30, view event outcome selections 34, event outcome selection button 35a-35d and so forth when interacting with Molly's profile in the same manner as described above.

One advantage present in various embodiments is that a user has a wider pool of entities to search through. Another advantage is that a user does not have to sign up with several platforms to search through the users on those platforms. Additionally, an advantage that exists in various embodiments is that a user does not have to understand the implicit question associated with event labeled types due to our event outcome selection server 14 turning implicit questions into explicit questions. Another advantage that exists in various embodiments is that a user does not have to understand the odds associated with event labeled types due to our event outcome selection server 14 identifying the odds notation, turning odds into implied improbabilities and normalizing implied probabilities on a numerical scale. Thus, the user has a normalized labeled type-derived explicit questions and numerical scale representations—and event details—presented in a greatly simplified manner.

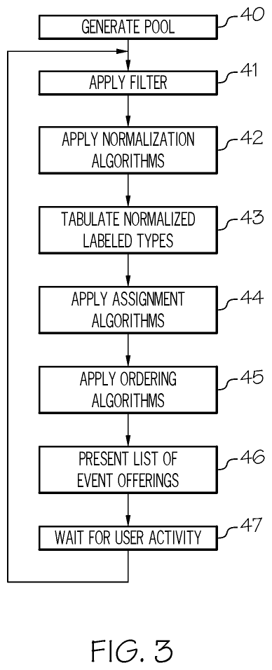

FIG. 3 is a flowchart illustrating one embodiment of how result list 26 may be generated. At step 40, event outcome selection server 14 generates pool 25, as described above. At step 41, event outcome selection server 14 applies a filter to pool 25, removing certain entities; in various embodiments, this filter is based on user 10 characteristics, event offering participation and event outcome selections. At step 42, event outcome selection server 14 may be configured to apply algorithms to pool 25 that will generate a plurality of normalized labeled types for each entity in pool 25. In one embodiment, these algorithms may include analyzing event labeled types of event offerings of the entities in pool 25 to identify implicit questions and odds notation, convert implicit to explicit questions, convert odds notation to implied probabilities, and normalize implied probabilities to numerical scale. At step 43, event outcome selection server 14 may be configured to collect all of the normalized event labeled types from step 42; in one embodiment, event outcome selection server 14 may use database 22b to store all of these normalized labeled types. At step 44, event outcome selection server 14 may be configured to apply an assignment algorithm which will associate normalized labeled types, event details and event results with event offerings. At step 45, event outcome selection server 14 may be configured to apply an ordering algorithm which will determine the order in which entities in result list 26 are presented to user 10. In one embodiment, this ordering algorithm is based, in part, on the normalization algorithms applied at step 42. In another embodiment, this ordering algorithm is based on the event offering preferences of the user and select event details.

As an example only, consider a registered user, Billy, who desires to perform a search. Before processing the request, event outcome selection server 14 may ask Billy what event offeror he prefers; in this example, Billy responds that he prefers the National Basketball Association (NBA) as the event offeror. After doing so, event outcome selection server 14 will generate pool 25 as described above. Next, event outcome selection server 14 will apply a filter to remove certain entities from pool 25. In this example, user profiles not associated with Billy and event offerings will be removed from pool 25 since Billy is seeking the NBA. After pool 25 has been filtered, event outcome selection server 14 applies a variety of normalization algorithms to the entities remaining in pool 25. These algorithms may account for transforming various event labeled types composed of implicit questions like moneyline, over/under or spread and odd notations like moneyline (−400), decimal (1.25) or fractional (¼). Additionally, these algorithms may account for converting implicit questions to explicit questions such as “Who will win?”, “Will Lebron James score more or less than 25 points?” and “Will the Knicks win by more than 5 points?”, and converting odds notations to implied probabilities.

Then, the implied probabilities are normalized on a numerical scale which may be called points. As an example, the following table delineates one possible expression of points:

TABLE 1
Conversion of implied probabilities to points

| Implied Probabilities | Points |
|---|---|
| 0% | 100 |
| 10% | 90 |
| 20% | 80 |
| 30% | 70 |
| 40% | 60 |
| 50% | 50 |
| 60% | 40 |
| 70% | 30 |
| 80% | 20 |
| 90% | 10 |
| 100% | 0 |

Event outcome selection server 14 will then tabulate these normalized event labeled types, storing them, in this example, in database 22b. Event outcome selection server 14 will then assign these normalized event labeled types, event details and event results to event offerings as described above. Event outcome selection server 14 will then determine what order these entities are presented to Billy by applying an ordering algorithm. Here, event outcome selection server 14 assigns one ordering based on the start date and time of the events of the NBA event offering. After doing so, event outcome selection server 14 will present result list 26 to Billy, where the order of the entities that appear in the result list is based on the ordering algorithm. In this example, it is possible for result list 26 to change.

Consider another user, Molly. Event outcome selection server 14 will update the pool, apply the filters, apply the normalization algorithms, tabulate the results, apply the assignment algorithm, apply the ordering algorithm, and update result list 26. As another example, an entity may update their profile which could be, but not limited to, characteristics and event outcome selections of event offerings, which can change result list 26. For example, assume Billy changes his profile to include the National Football League (NFL) events as a preference which results in retrieving the NFL event offering in his profile search. Event outcome selection server 14 will then update his normalization algorithms. In this example, the change in Billy's profile and availability of non-started NFL matchups lead to the NFL event offering and events being selected for Billy's initial request. This was then reflected in the ordering algorithm as it was also applied to the updated profile. Afterwards, Billy's profile is now including the NFL along with the NBA in result list 26.

In some embodiments, event outcome selection server 14 may be configured to receive required characteristics from user 10 regarding event outcome selection. User 10 may be allowed to specify such restrictions based upon any number of characteristics, including those described herein. For example, event outcome selection server 14 may allow user 10 to specify that only entities between the ages of 18 and 30 should be present in result list 26. In some embodiments, event outcome selection server 14 may implement these restrictions in step 41 of FIG. 3. In in other embodiments, however, event outcome selection server 14 may refuse to apply these restrictions to certain entities based on the characteristics of the entities. Any number of characteristics, including those described herein, may form the basis upon which event outcome selection server 14 decides not to apply the restrictions submitted by user 10. As an example only, event outcome selection server 14 may ignore the restrictions if the entity is in a location that allows users younger than 18 to participate in selecting event outcomes. Additionally, in some embodiments, event outcome selection server 14 may refuse to apply restrictions submitted by user 10 based on any combination of characteristics or algorithms.

An advantage present in many embodiments is that through taking into account various factors when normalizing event labeled types for events in event offerings and using only very few strict filters, a large amount of result entities may be returned to the user. An additional advantage is that the assigning algorithm will put the most relevant event information to the user, therefore saving the user time by not going to multiple places for additional information. A further advantage is that the ordering algorithm will put the most relevant search results first, saving the user time.

In some embodiments, event outcome selection server 14 may be configured to apply a relevance algorithm which determines the content and order in which event outcome selection server 14 displays event offerings and its events to user 10. A relevance algorithm may be based on both explicit and implicit signals from user 10. Explicit signals include information entered by user 10 as part of its user profile, such as age, location, gender and ethnicity. Explicit signals may also include information about the event offerings user 10 is seeking for event outcome selection, such as event details, explicit questions, possible entertainment outcomes and reward breakdown of correct and wrong selections. Explicit signals may also be entered by user 10 as part of a search request. For example, user 10 may request event outcome selection server 14 limit the pool of potential entertainment event offerings and events to those within the National Basketball Association (NBA). Event outcome selection server 14 is operable to compare event offerings associated with the plurality of user profiles in user profile pool 25 with a preference for an event offering associated with user 10. Explicit signals may be imported from a free-to-play, betting and social networking platforms 38, such as the number of shared entities in a social graph of user 10. Implicit signals may be based on the behavior of user 10 either within system 100 or other free-to-play, betting and social networking platforms 38. For example, if user 10 has expressed disapproval of a certain event offering, event outcome offering server 14 may no longer present the disapproved event offering to user 10 in future searches. In various embodiments, event outcome offering server 14 may be configured to evaluate the attractiveness of an event offering in user profile pool 25 through collected feedback from other users. For example, event outcome offering server 14 may rank an event offering that receives more participants as more relevant than an event offering that receives fewer participants. In particular embodiments, event outcome offering server 14 may assign a higher relevance to an event offering for user 10 if other users, with similar traits, have previously expressed a preference for event offerings. As an example, user Billy may have previously expressed a preference for Major League Soccer (MLS). If Molly requests a set of event offerings from event outcome selection server 14, and Billy's user profile shows similar traits to Molly, event outcome offering server 14 may assign Billy's preferred event offerings higher relevance to Molly. This can result in Billy's preferred event offerings being presented to Molly sooner than other-wise would have occurred. This may be advantageous in that it can increase the chances of event outcome selections without compromising a user's feelings of privacy when expressing preferences for event offerings. In some embodiments, event outcome selection server 14 may be configured to use the fate characteristics as a metric in the relevance algorithm.

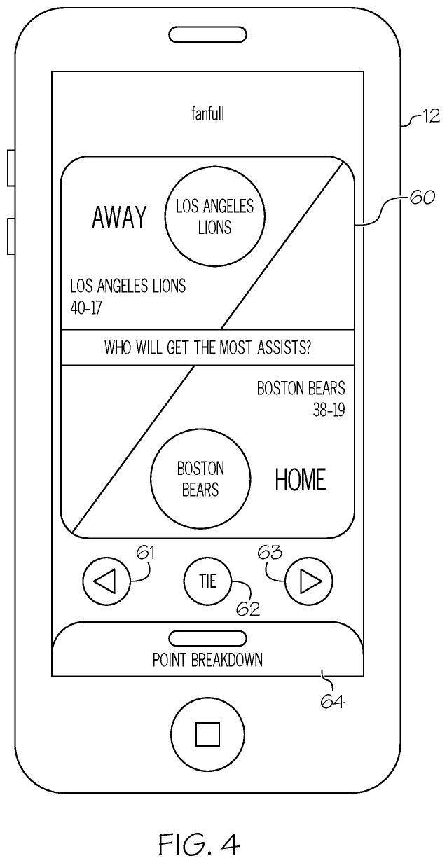

FIGS. 4-11 depict embodiments of a user interface presented to users of the event outcome selection system discussed above with respect to FIGS. 1A, 2 and 3. According to some embodiments, user 10 interacts with event outcome selection server 14 through interface 18 presented by terminal 12. In addition to the embodiments of interface 18 described above in relation to FIG. 1A, interface 18 may also comprise a touch screen interface operable to detect and receive touch input such as a tap or a swiping gesture.

FIG. 4 shows one embodiment of event outcome selection server 14 presenting events to user 10 after searching through and filtering its plurality of event offerings. In this embodiment, a plurality of events comprising event details and normalized labeled types (explicit questions and points as described above) are presented to user 10. Using terminal 12, user 10 may request that event outcome selection server 14 present a subset of event details from event offering pool 25 based on specified search parameters. The display may show an image of event details and one or more aspects of profile information associated with user 10. In some embodiments, one or more aspects of event details is displayed as “card” 60 representing the range of event offerings. A set of suggested events may be displayed as a stack of cards 60. User 10 may view information regarding one suggested event at a time or more than one suggested event at a time. User 10 may be presented with a summary of information regarding a suggested event. The summary may include one or more of: a picture, an icon, a logo, name, location information, date and time, quantitative or qualitative data or other profile information which includes user traits and event offerings as described herein. In some events, the user interface may also include an element that lets the user 10 specify an amount to wager on their successful prediction of an event outcome.

In some embodiments, terminal 12 may also display “Point Breakdown” tab 64 which could be referred to as the point breakdown which allows user 10 to request event outcome selection server 14 retrieve and display more information about the reward or loss associated with selecting particular event outcomes. In addition, user 10 may express an event outcome selection given possible outcomes of the event. Expressing a selection can be accomplished through various methods. For example, terminal 12 may display “right” button 63 (represented by an adjustable colored “→” icon), “left” button 61 (represented by an adjustable colored “←” icon) and “Tie” button 62. Pressing right button 63 indicates to event outcome selection server 14 that user 10 approves of designated event outcome and believes it will occur in the future. Pressing left button 61 indicates that user 10 approves of another possible event outcome and believes it will occur in the future. Pressing tie button 62 indicates that user 10 approves of another possible event outcome and believes it will occur in the future.

With reference to FIG. 4, consider a registered user, Billy, who has profiles stored in event outcome selection server 14. Billy is at the barbershop and requests event outcome selection server 14 to present him an event offering. If an event offering has an event or events with event details stating it has not started yet, event outcome selection server 14 will present Billy with one or more events. If other event offerings also meet Billy's search criteria or preferences, event outcome selection server 14 may present one or more events of those event offerings as well.

The first event offering concerns the Los Angeles Lions playing the Boston Bears, and the user interface of FIG. 4 permits Billy to select which team will get the most assists during the game. The interface denotes that the Los Angeles Lions are the away team, while the Boston Bears are the home team. The interface also indicates that Los Angeles Lions won 40 of their past 57 games, while the Boston Bears won 38 of their past 57 games. However, the interface may instead or additionally display a statistic that is relevant to the explicit question. Here, for example, the interface could indicate that the Lions average 19 assists per game while the Bears average 25 assists per game.

A sportsbook or televised sports program may present this event offering as:

| | | |
|---|---|---|
| Moneyline (ML) Assists | L.A. Lions | −150 |
| | Boston Bears | +233 |
| | Tie | +900 |

This means that a bettor selecting the Lions will win $100 for every $150 bet, i.e., 67 cents for every dollar bet; a bettor selecting the Bears will win $233 for every $100 wagered, i.e., $2.33 for every dollar bet; and a bettor selecting a tie will win $900 for every $100 wagered, i.e., $9 for every dollar bet.

In accord with the present invention, the implicit question, i.e., “Moneyline (ML) Assists” is converted to the explicit question, “Who will get the most assists?” The implied probability of the L.A. Lions winning this proposition is:

Pᵢ(Aₙ)=−Aₙ/(100−Aₙ)

Pᵢ(−150)=150/(100+150)

Pᵢ(−150)=0.6

i.e., 60%. This probability implied by the odds offered can be normalized to a point scale in a variety of ways in accord with the present invention. Per table 1, above, the 60% implied probability of the L.A. Lions receiving the most assists is converted to 40 points. If Billy selects the Lions and they receive the most assists, then Billy will be awarded 40 points given the Lions were favorites based on the probability implied by the odds offered. Billy will be awarded fewer points for successfully predicting the outcome by selecting a favorite. If Billy selects the Lions but the Bears receive the most assists or the Lions and Bears tie, then Billy will lose 60 points because the implied probability of the Bears receiving the most assists or the Lions and Bears tying is 40% and, per Table 1, the normalized point value of that implied probability is 60 points. Billy will be penalized more points for wrongly selecting a favorite.

In this example, the implied probability of the Bears winning this proposition is:

Pᵢ(Aₚ)=100/(100+Aₚ)

Pᵢ(+233)=100/(100+233)

Pᵢ(+233)=0.3

i.e., 30%. This probability implied by the odds offered can be normalized to a point scale in a variety of ways in accord with the present invention. Per Table 1, above, the 30% implied probability of the Boston Bears receiving the most assists is converted to 70 points. If Billy selects the Bears and they receive the most assists, then Billy will be awarded 70 points given the Lions were underdogs based on the probability implied by the odds offered. Billy will be awarded more points for successfully predicting the outcome by selecting an underdog. If Billy selects the Bears but the Lions receive the most assists or the Lions and Bears tie, then Billy will lose 30 points because the implied probability of the Lions receiving the most assists or the Lions and Bears tying is 70% and, per Table 1, the normalized point value of that implied probability is 30 points. Billy will be penalized fewer points for wrongly selecting an underdog.

In this example, the implied probability of the Bears and the Lions receiving the same number of assists is:

Pᵢ(Aₚ)=100/(100+Aₚ)

Pᵢ(+900)=100/(100+900)

Pᵢ(+900)=0.1

i.e., 10%. This probability implied by the odds offered can be normalized to a point scale in a variety of ways in accord with the present invention. Per Table 1, above, the 10% implied probability of the teams tying is converted to 90 points. If Billy selects the Lions and Bears tying and the teams tie, then Billy will be awarded 90 points because is the least likely outcome based on the probability implied by the odds offered. Billy will be awarded more points for successfully predicting the outcome by selecting the most unlikely outcome. If teams do not tie, then Billy will lose 10 points because the implied probability of the teams not tying is 90% and, per Table 1, the normalized point value of that implied probability is −10 points. Billy will be penalized fewer points for wrongly selecting the most unlikely outcome.

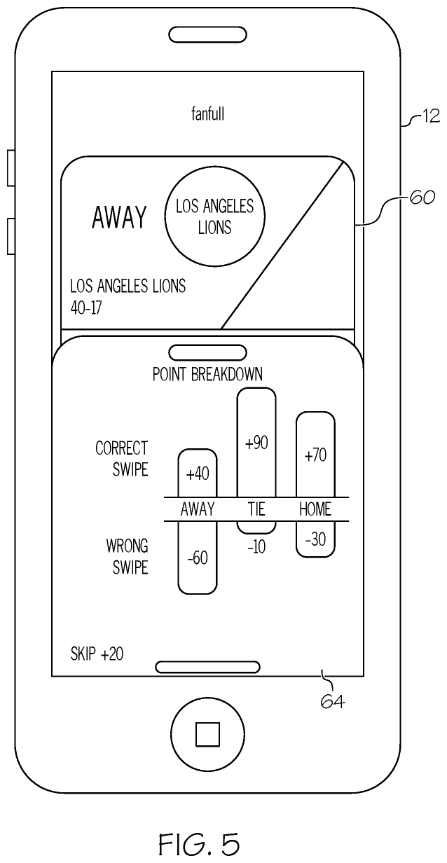

Billy may request more information on the event by pressing point breakdown tab 64 in which the display shown in FIG. 5 will be shown. Note that the display now shows the points associated with each option computed as discussed. In addition, the user may receive 20 points for skipping this event and not predicting an outcome. This number may be set arbitrarily.

Billy submits an event outcome selection, i.e., the Boston Bears, by pressing the right button 63. Event outcome selection server 14 processes Billy's response in CPU 20 and records it in the user profile stored in the memory 22, database 22a or 22b.

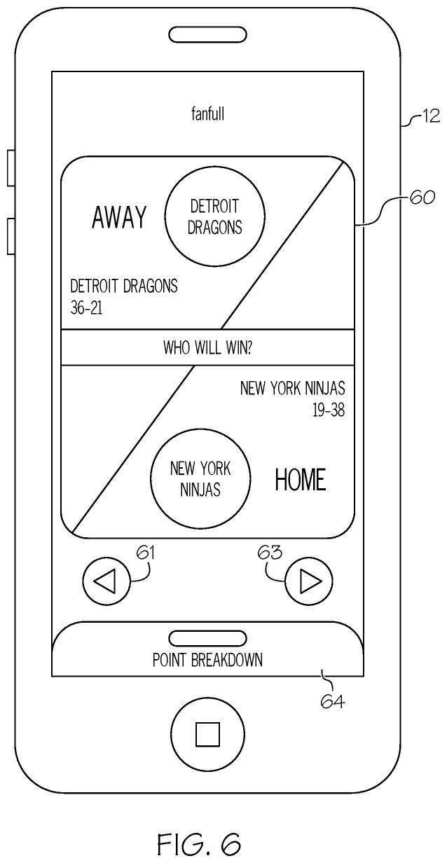

FIG. 6 illustrates another exemplary event offering, where the Detroit Dragons and playing the New York Ninjas and the user is prompted to select which team will win the game outright. The interface denotes that the Dragons are the away team, while the Ninjas are the home team. The interface also indicates that Dragons have won 36 of their past 57 games, while the Ninjas won 19 of their past 57 games.

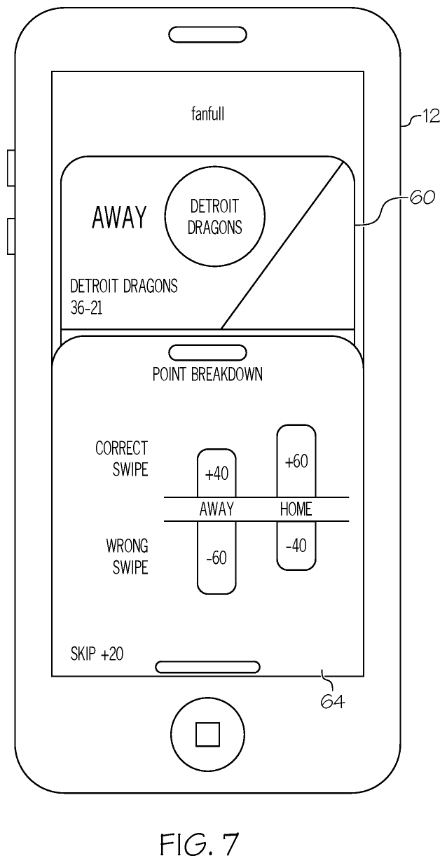

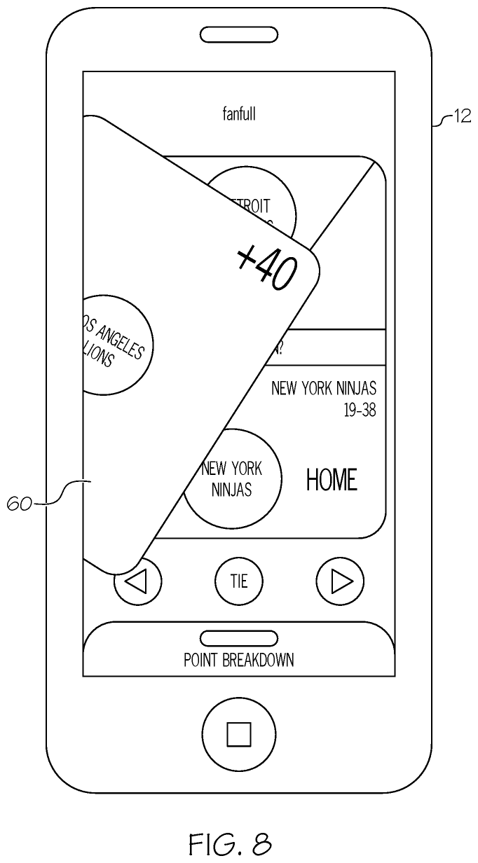

A user may request more information on the event by pressing point breakdown tab 64 in which the display shown in FIG. 7 will be shown. Note that the display now shows the points associated with each option computed as discussed above.

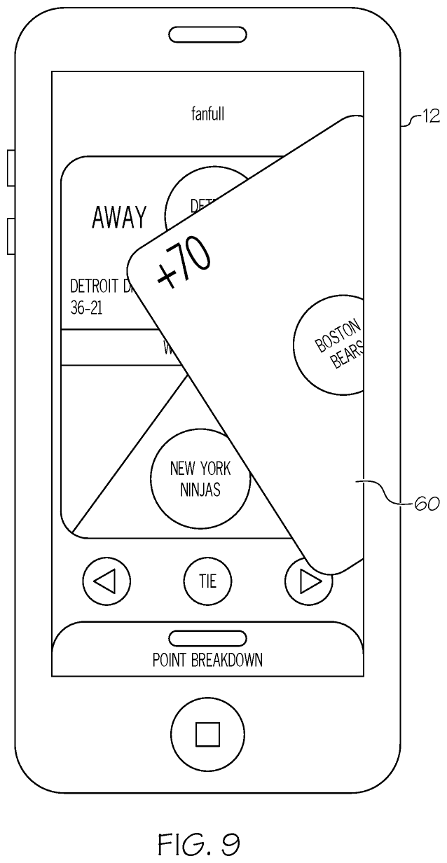

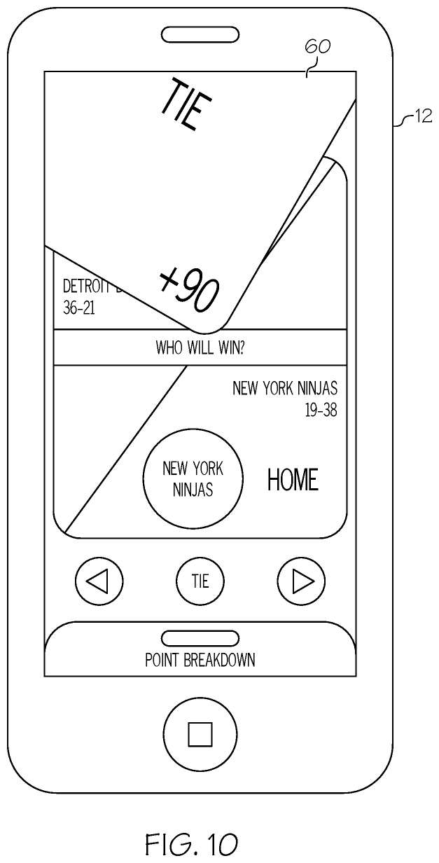

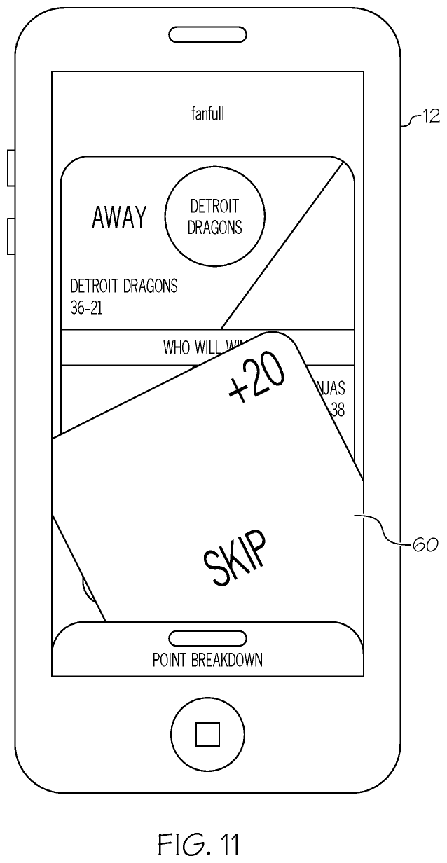

FIGS. 8, 9, 10 and 11 are diagrams of embodiments of the display from FIG. 6 showing the effect of a left swipe gesture (FIG. 8), the effect of a right swipe gesture (FIG. 9), the effect of an up swipe gesture (FIG. 10), and the effect of a down swipe gesture (FIG. 11). In one embodiment, users 10 may navigate through the set of presented event offerings by swiping through stack of cards 60. Users 10 may also express a particular event outcome preference of a presented event by performing a right swipe gesture. Users 10 may also express another unique event outcome preference by performing a left swipe gesture. Users 10 may also express another unique event outcome preference by performing an up swipe gesture and express another unique event outcome preference by performing a down swipe gesture. In some embodiments, user 10 performs a swiping gesture by moving a finger or other suitable object across a screen of terminal 12. Other suitable gestures or manners of interacting with terminal 12 may be used (e.g., tapping on portions of a screen of terminal 12).

In some embodiments, one advantage of a system presenting event outcome selections based on preferences of user profiles is that a user does not have to spend excessive time and consideration in searching, understanding and selecting event outcome options of events within event offerings. This may lead to users more actively expressing their outcome selection preferences and increasing their engagement with the system. Such increased activity can be used by the event outcome selection system to identify and present more event offerings for the user.

In some embodiments, event outcome selection server 14 may be configured to allow direct communication between users when there has been a mutual expression of event outcome preferences that partially or fully match. This may be advantageous because users can build camaraderie through shared beliefs or experiences.

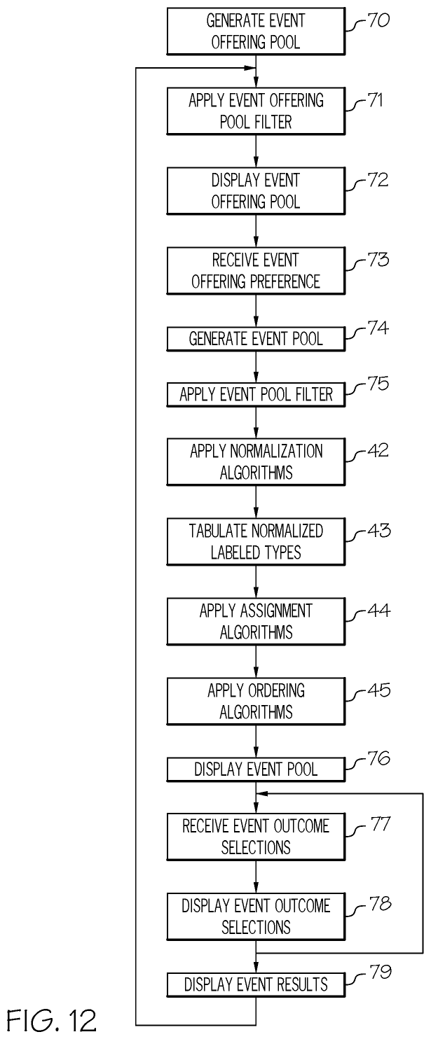

FIG. 12 is a flowchart depicting a method for event outcome selection based on a plurality of event offerings, each event offering comprising of a plurality of events which comprise of a plurality of labeled types, event details (quantitative or qualitative data), user event outcome selections and event results of respective events, in accordance with a particular embodiment.

At step 70, in some embodiments, event outcome selection server 14 generates a set of event offerings in response to a request from a user 10. As an example, event outcome selection server 14 may provide a registered user, Billy, event offerings like the NBA, MLB and The Bachelor. At step 71, event outcome selection server 14 filters an event offering pool, removing certain entities; in various embodiments, this filter is based on user 10 characteristics, event offering participation and event outcome selections. As an example, Billy may not live in a country that shows The Bachelor, thus event outcome selection server 14 may include filtering out said event offering due to geographical location. At step 72, event outcome selection server 14 displays the pool of event offerings to user 10. At step 73, event outcome selection server 14 awaits on user 10 to select an event offering from the displayed pool. At step 74, event outcome selection server 14 generates a set of events given the selected event offering in step 73; for example, Billy may select NBA in which case the event outcome selection server 14 will present additional events of the NBA. At step 75, in some embodiments, these additional events may be filtered, removing certain entities given event details and user 10 traits. As an example, event outcome selection server 14 may remove past NBA events that have concluded.

Steps 42-45 of FIG. 12 are similar to those discussed above in connection with FIG. 3. At step 42, event outcome selection server 14 may be configured to apply algorithms to a set of events that will generate a plurality of normalized labeled types for each entity in the event pools described above. At step 43, event outcome selection server 14 may be configured to collect all of the normalized event labeled types from step 42 as discussed above. At step 44, event outcome selection server 14 may be configured to apply an assignment algorithm which will associate normalized event labeled types, event details and event results with event offerings as described above. At step 45, event outcome selection server 14 may be configured to apply an ordering algorithm which will determine the order in which event entities are presented to user 10 as delineated herein.

At step 76, event outcome selection server 14 displays the pool of events to user 10. As an example, event outcome selection server 14 may show the event pool as cards 60 to a registered user, Billy. At step 77, event outcome selection server 14 awaits on Billy to select event outcomes from the displayed pool of events. For example, Billy may make a right swipe gesture on a card in order to confirm an event outcome selection. In step 78, in various embodiments, event outcome selection server 14 may display user 10 event outcome selections. Furthermore, event outcome selection server 14 may give user 10 the ability to make a change to their previous event outcome selections. As an example, event outcome selection server 14 may present all of Billy's event outcome selections to Billy on display 16. Additionally, Billy may decide to make a change to an event outcome selection of an event. Event outcome selection server 14 will allow Billy to make a change to event outcome selections given the event associated with the selection has not started. Furthermore, if Billy decides to make a change to event outcome selections for an event that has started, event outcome selection server 14 may deny Billy's request to change event outcome selection.

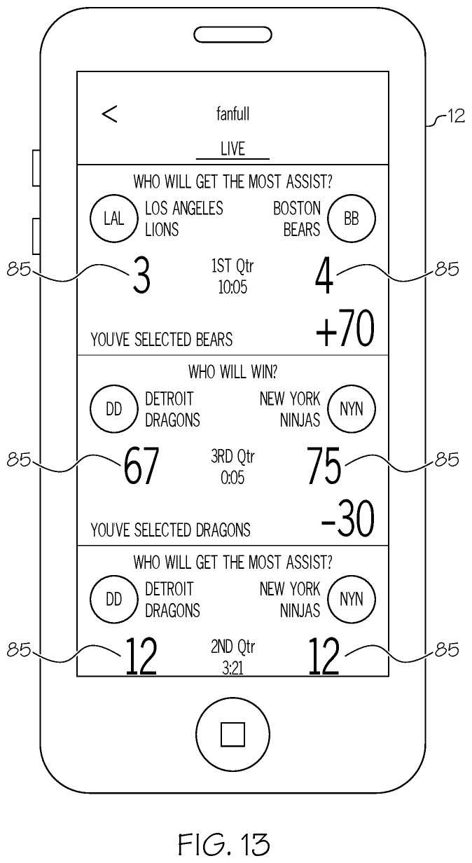

At step 79, in some embodiments, event outcome selection server 14 dynamically displays the event results to user 10 on display 16 as depicted in FIG. 13. These results may include statistics 85 relevant to the explicit question of the normalized labeled type of the event. As an example, event outcome selection server 14 may present all of Billy's event outcome selections individually or simultaneously on display 16 for easy review. Once Los Angeles Lions vs Boston Bears event starts, event outcome selection server 14 dynamically displays that event results, event details, isolated statistics, such as points, and explicit question to Billy on display 16. Furthermore, once Detroit Dragons vs New York Ninjas event starts, event outcome selection server 14 dynamically displays that event results, event details, isolated statistics and explicit question to Billy on display 16.

Modifications, additions, or omissions may be made to the methods described herein (such as those described above with respect to FIGS. 3 and 12) without departing from the scope of the disclosure. For example, the steps may be combined, modified, or deleted where appropriate, and additional steps may be added. Additionally, the steps may be performed in any suitable order without departing from the scope of the present disclosure.

Although several embodiments have been illustrated and described in detail, it will be recognized that substitutions and alterations are possible without departing from the spirit and scope of the appended claims. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A computer-implemented method of event outcome selection comprising:
electronically receiving, by a first computer system, at least one user profile via an interface configured to communicate with at least one other computer system, the user profile including at least one event outcome selection made by a user associated with the user profile;
electronically receiving, by the first computer system, at least one event having a plurality of outcomes, each outcome associated with a payout associated with an implied probability of occurrence of the outcome;
converting, by the first computer system, each implied probability of occurrence to a normalized value; and
communicating, by the first computer system via the interface, a first graphical user interface for display to the user associated with the user profile, the first graphical user interface allowing the user to choose among a plurality of outcomes using a swiping gesture, each of the plurality of outcomes being associated with a converted normalized value.

2. The method of claim 1, further comprising communicating, by the first computer system via the interface, a second graphical user interface for display to an administrative user, the second graphical user interface enabling the administrative user to alter at least one event outcome selection associated with a user profile.

3. The method of claim 1, further comprising communicating, by the first computer system via the interface, a second graphical user interface for display to an administrative user, the second graphical user interface enabling the administrative user to create a user pool based on a seed user.

4. The method of claim 1, further comprising communicating, by the first computer system via the interface, a second graphical user interface for display to an administrative user, the second graphical user interface enabling the administrative user to seamlessly interact with a user profile originated at the first computer system and at least one user profile received from at least one other computer system.

5. The method of claim 1, further comprising:
filtering, by the first computer system, at least one received event using at least one of user signals, user characteristics, event offering participation, and event outcome selections associated with the user profile; and
presenting, using the first graphical user interface, the list of filtered events to the user and receiving user choices for each of the filtered events.

6. The method of claim 5, wherein the presented list of filtered events is ordered according to user preferences.

7. The method of claim 1, further comprising communicating, by the first computer system via the first graphical user interface, additional outcomes based on the outcomes chosen by the user using the first graphical user interface.

8. A non-transitory computer-readable medium comprising instructions for event outcome selection that, when executed by a processor, are configured to:
electronically receive, by a first computer system, at least one user profile via an interface configured to communicate with at least one other computer system, the user profile including at least one event outcome selection made by a user associated with the user profile;
electronically receive, by the first computer system, at least one event having a plurality of outcomes, each outcome associated with a payout associated with an implied probability of occurrence of the outcome;
convert, by the first computer system, each implied probability of occurrence to a normalized value; and
communicate, by the first computer system via the interface, a first graphical user interface for display to the user associated with the user profile, the first graphical user interface allowing the user to choose among a plurality of outcomes using a swiping gesture, each of the plurality of outcomes being associated with a converted normalized value.

9. The medium of claim 8, further comprising instructions for communicating, by the first computer system via the interface, a second graphical user interface for display to an administrative user, the second graphical user interface enabling the administrative user to alter at least one event outcome selection associated with a user profile.

10. The medium of claim 8, further comprising instructions for communicating, by the first computer system via the interface, a second graphical user interface for display to an administrative user, the second graphical user interface enabling the administrative user to create a user pool based on a seed user.

11. The medium of claim 8, further comprising instructions for communicating, by the first computer system via the interface, a second graphical user interface for display to an administrative user, the second graphical user interface enabling the administrative user to seamlessly interact with a user profile originated at the first computer system and at least one user profile received from at least one other computer system.

12. The medium of claim 8, further comprising instructions for:
filtering, by the first computer system, at least one received event using at least one of user characteristics, user signals, event offering participation, and event outcome selections associated with the user profile; and
presenting, using the first graphical user interface, the list of filtered events to the user and receiving user choices for each of the filtered events.

13. The medium of claim 12, wherein the instructions for presenting the list of filtered events to the user comprise instructions for presenting the list of filtered events ordered according to user preferences.

14. The medium of claim 8, further comprising instructions for communicating, by the first computer system via the first graphical user interface, additional outcomes based on the outcomes chosen by the user using the first graphical user interface.

15. A computer system for event outcome selection comprising:
a processor configured to:
receive at least one event having a plurality of outcomes each outcome associated with a payout associated with an implied probability of occurrence of the outcome; and
convert each implied probability of occurrence to a normalized value; and
an interface coupled to the processor and operable to:
electronically receive at least one user profile from at least one other computer system, the user profile including at least one event outcome selection made by a user associated with the user profile; and
communicate a first graphical interface for display to the user associated with the user profile, the first graphical user interface allowing the user to choose among a plurality of outcomes using a swiping gesture, each of the plurality of outcomes being associated with a converted normalized value.

16. The system of claim 15 wherein the interface is further operative to communicate a second graphical user interface for display to an administrative user, the second graphical user interface enabling the administrative user to alter at least one event outcome selection associated with a user profile.

17. The system of claim 15 wherein the interface is further operative to communicate a second graphical user interface for display to an administrative user, the second graphical user interface enabling the administrative user to create a user pool based on a seed user.

18. The system of claim 15 wherein the interface is further operative to communicate a second graphical user interface for display to an administrative user, the second graphical user interface enabling the administrative user to seamlessly interact with a user profile originated at the first computer system and at least one user profile received from at least one other computer system.

19. The system of claim 15, wherein:
the processor is further configured to filter at least one received event using at least one of user characteristics, user signals, event offering participation, and event outcome selections associated with the user profile; and
the first graphical user interface is further configured to present the list of filtered events to the user and receive choices from the user for each of the filtered events.

20. The system of claim 19, wherein the first graphical user interface is further configured to present the list of filtered events ordered according to user preferences.
